(19) United States
(12) Patent Application Publication
(10) Pub. No.: US 2023/0376890 A1
(43) Pub. Date: Nov. 23, 2023

(54) DISPLAY CONTROL APPARATUS, DISPLAY CONTROL METHOD, AND NON-TRANSITORY COMPUTER-READABLE MEDIUM

(71) Applicant: NEC Corporation, Minato-ku, Tokyo (JP)

(72) Inventors: Jun UCHIMURA, Tokyo (JP); Hiroki Sugegaya, Tokyo (JP)

(73) Assignee: NEC Corporation, Minato-ku, Tokyo (JP)

(21) Appl. No.: 18/031,441

(22) PCT Filed: Oct. 21, 2020
(86) PCT No.: PCT/JP2020/039575

§ 371 Date: Apr. 12, 2023

(51) Int. Cl. G06Q 10/087

(52) U.S. Cl. CPC G06Q 10/087

(57) ABSTRACT

A display control apparatus includes a stock information acquisition unit, an apparatus information acquisition unit, and a display control unit. The stock information acquisition unit acquires product identification information, and stock information of a product associated with the product identification information in a store. The apparatus information acquisition unit uses information stored in an apparatus information storage unit. The apparatus information storage unit stores display apparatus identification information of a display apparatus, and product identification information associated with the display apparatus in association with each other. Further, the apparatus information acquisition unit acquires, from the apparatus information storage unit, display apparatus identification information associated with the acquired product identification information. The display control unit sets the display apparatus associated with the acquired display apparatus identification information to a display state associated with the acquired stock information.

### TECHNICAL FIELD

The present invention relates to a display control apparatus, a display control method, and a program.

### BACKGROUND ART

In recent years, as represented by an electronic shelf label and the like, providing a display apparatus on a product shelf where a product is disposed has been increasing. For example, Patent Document 1 describes that a sales area where a product is disposed is divided into a plurality of communication areas, and product information is provided on an electronic shelf label in a unit of each communication area. Further, Patent Document 1 also describes that, in a case where an electronic shelf label and a product are unlinked, image data for unlinking are transmitted to the electronic shelf label.

Patent Document 2 describes that a button is provided on an electronic shelf label, and when the button is pressed by a customer, the electronic shelf label requests for a stock status of a product associated with the shelf label.

### RELATED DOCUMENT

### Patent Document

Patent Document 1: Japanese Patent Application Publication No. 2011-48631

Patent Document 2: Japanese Patent Application Publication No. 2016-177744

### SUMMARY OF THE INVENTION

### Technical Problem

In a facility such as a store or a warehouse, changing a display pattern of a display apparatus such as an electronic shelf label by using information related to stock of a product enables to provide useful information to a user in the facility via the display apparatus. One example of an object of the present invention is to change, in a facility such as a store or a warehouse, a display pattern of a display apparatus such as an electronic shelf label by using information related to stock of a product.

### Solution to Problem

The present invention provides a display control apparatus including:
a stock information acquisition unit that acquires product identification information and stock information, the stock information being information related to stock of a product associated with the product identification information in a facility;
an apparatus information acquisition unit that acquires, from an apparatus information storage unit that stores display apparatus identification information for identifying a display apparatus provided on a product shelf within the facility and product identification information associated with the display apparatus in association with each other, the display apparatus identification information associated with the product identification information acquired by the stock information acquisition unit; and
a display control unit that sets the display apparatus associated with the display apparatus identification information acquired by the apparatus information acquisition unit to a display state associated with the stock information acquired by the stock information acquisition unit.

The present invention provides a display control method including,
by a computer:
stock information acquisition processing of acquiring product identification information and stock information, the stock information being information related to stock of a product associated with the product identification information in a facility;
apparatus information acquisition processing of acquiring, from an apparatus information storage unit that stores display apparatus identification information for identifying a display apparatus provided on a product shelf within the facility and product identification information associated with the display apparatus in association with each other, the display apparatus identification information associated with the product identification information acquired by the stock information acquisition unit; and
display control processing of setting the display apparatus associated with the acquired display apparatus identification information to a display state associated with the acquired stock information.

The present invention provides a program causing a computer to include:
a stock information acquisition function of acquiring product identification information and stock information, the stock information being information related to stock of a product associated with the product identification information in a facility;
an apparatus information acquisition function of acquiring, from an apparatus information storage unit that stores display apparatus identification information for identifying a display apparatus provided on a product shelf within the facility and product identification information associated with the display apparatus in association with each other, the display apparatus identification information associated with the product identification information acquired by the stock information acquisition unit; and
a display control function of setting the display apparatus associated with the acquired display apparatus identification information to a display state associated with the acquired stock information.

### Advantageous Effects of Invention

According to the present invention, it is possible to change, in a facility such as a store or a warehouse, a display pattern of a display apparatus such as an electronic shelf label by using information related to stock of a product.

### BRIEF DESCRIPTION OF THE DRAWINGS

The above-described object, the other objects, features, and advantages will become more apparent from a suitable example embodiment described below and the following accompanying drawings.

FIG. 1 is a diagram illustrating a usage environment of a display control apparatus according to an example embodiment.

FIG. 2 is a diagram illustrating one example of a functional configuration of the display control apparatus.

FIG. 3 is a diagram illustrating one example of information stored in an apparatus information storage unit.

FIG. 4 is a diagram illustrating one example of information stored in a display information storage unit.

FIG. 5 is a diagram illustrating one example of information stored in a stock management apparatus.

FIG. 6 is a diagram illustrating a hardware configuration example of the display control apparatus.

FIG. 7 is a diagram illustrating one example of a flowchart illustrating processing to be performed by the display control apparatus.

FIG. 8 is a diagram illustrating one example of a functional configuration of a display control apparatus according to a modification example.

### DESCRIPTION OF EMBODIMENTS

Hereinafter, an example embodiment according to the present invention is described with reference to the drawings. Note that, in all drawings, a similar constituent element is indicated by a similar reference sign, and description thereof is omitted as necessary.

### Example Embodiment

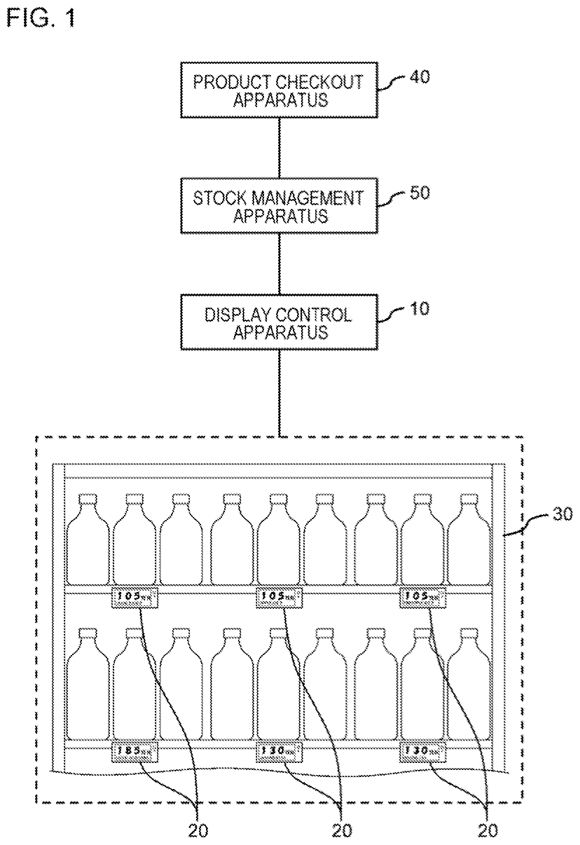

FIG. 1 is a diagram illustrating a usage environment of a display control apparatus 10 according to an example embodiment. The display control apparatus 10 is used together with a display apparatus 20, a product checkout apparatus 40, and a stock management apparatus 50.

The display apparatus 20 is, for example, an electronic shelf label or a signage, and is provided in a facility. The facility is, for example, a store or a logistics base warehouse. Hereinafter, description is made based on a premise that the facility is a store. The display apparatus 20 is mounted on a product shelf 30. The display apparatus 20 is provided for each of a plurality of kinds of products, and displays information (hereinafter, described as display information) related to a product associated with the display apparatus 20. The display information includes, for example, a product name and a price, but may also include description of a product.

The product checkout apparatus 40 is, for example, a POS terminal, and includes a product registration function of registering a product desired to be purchased by a customer, and a checkout function of making checkout of the registered product. The product checkout apparatus 40 may be operated by a customer, or may be operated by a salesperson. Further, the product registration function and the checkout function of the product checkout apparatus 40 may be physically achieved by a different apparatus. In this case, the product registration function is operated, for example, by a salesperson, and the checkout function is operated, for example, by a customer. Further, when a product is sold, the product checkout apparatus 40 transmits, to the stock management apparatus 50, product identification information indicating the sold product, and the number of the sold product.

The stock management apparatus 50 is, for example, a store computer, and stores stock of a product. The stock of the product is updated by using inspection processing of the product at a time of arrival, and information acquired from the product checkout apparatus 40. Specifically, stock of a product increases by inspection processing of the product at a time of arrival, and decreases by information acquired from the product checkout apparatus 40.

Further, the display control apparatus 10 sets a display state (e.g., presence or absence of display, and a content to be displayed) of the display apparatus 20 by using information (hereinafter, described as stock information) related to stock of a product associated with the display apparatus 20. The stock information includes a stock quantity. Further, when the stock quantity is 0, the stock information may further include information related to an arrival schedule.

Display apparatus identification information is allocated to the display apparatus 20. The display apparatus identification information is information for identifying a display apparatus from one another. The display apparatus 20 stores display apparatus identification information allocated to the display apparatus 20. Herein, the display apparatus 20 may store display apparatus identification information in a rewritable state, or may store in an unrewritable state. In the former case, display apparatus identification information is allocated, for example, to the display apparatus 20 in a store. In the latter case, display apparatus identification information is, for example, a serial number allocated to the display apparatus 20.

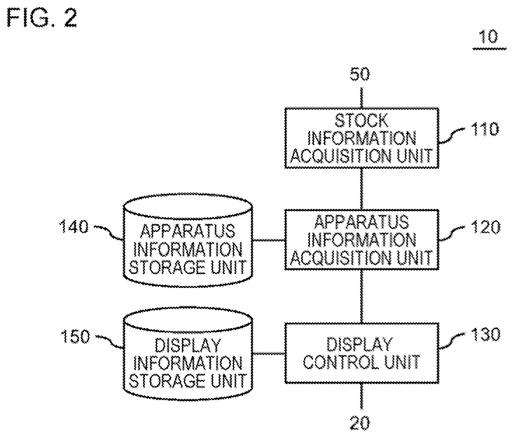

FIG. 2 is a diagram illustrating one example of a functional configuration of the display control apparatus 10. The display control apparatus 10 includes a stock information acquisition unit 110, an apparatus information acquisition unit 120, and a display control unit 130.

The stock information acquisition unit 110 acquires product identification information, and stock information of a product associated with the product identification information in a store. In the present example embodiment, the stock information acquisition unit 110 acquires product identification information and stock information from the stock management apparatus 50.

The apparatus information acquisition unit 120 uses information stored in an apparatus information storage unit 140. The apparatus information storage unit 140 stores display apparatus identification information of the display apparatus 20 and product identification information associated with the display apparatus in association with each other. Further, the apparatus information acquisition unit 120 acquires, from the apparatus information storage unit 140, display apparatus identification information associated with product identification information acquired by the stock information acquisition unit 110.

The display control unit 130 sets the display apparatus 20 associated with display apparatus identification information acquired by the apparatus information acquisition unit 120 to a display state associated with stock information acquired by the stock information acquisition unit 110. Herein, the display control unit 130 uses information stored in a display information storage unit 150, when controlling a display state of the display apparatus 20. The display information storage unit 150 stores stock information and information for setting to a display state associated with the stock information in association with each other.

In the example illustrated in FIG. 2, the apparatus information storage unit 140 and the display information storage unit 150 become a part of the display control apparatus 10. However, at least one of the apparatus information storage unit 140 and the display information storage unit 150 may be provided outside the display control apparatus 10.

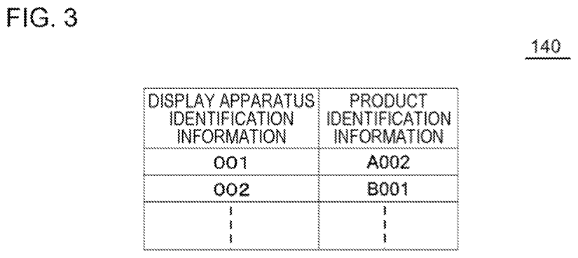

FIG. 3 is a diagram illustrating one example of information stored in the apparatus information storage unit 140. In the example illustrated in FIG. 3, the apparatus information storage unit 140 stores product identification information of a product associated with a display apparatus indicated by display apparatus identification information, for each piece of the display apparatus identification information. Note that, in a case where a same product is disposed on a plurality of product shelves 30, a plurality of pieces of display apparatus identification information are associated with one piece of product identification information in the apparatus information storage unit 140.

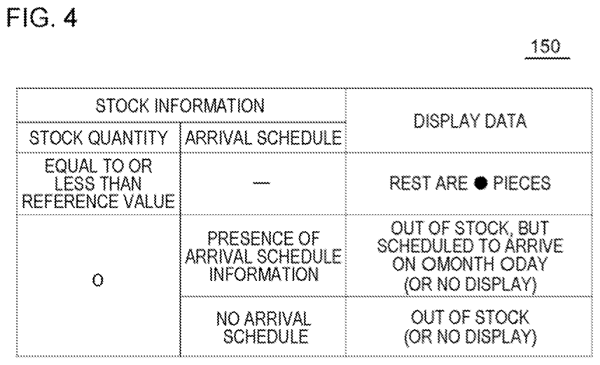

FIG. 4 is a diagram illustrating one example of information stored in the display information storage unit 150. The display information storage unit 150 stores information to be used by the display control unit 130, when the display control unit 130 controls a display pattern of the display apparatus 20. In the example illustrated in FIG. 4, the display control unit 130 stores display data to be displayed by the display apparatus 20, when a content is displayed, for each content indicated by stock information.

For example, when stock information indicates that the stock quantity is not 0, but is equal to or less than a reference value (e.g., 5), display data are data for causing the display apparatus 20 to display the stock quantity. Note that, the reference value may be set for each product (specifically, for each piece of product identification information). In this case, the display information storage unit 150 further stores the reference value for each piece of product identification information.

Further, when stock information indicates that the stock quantity is 0, but includes an arrival schedule for a next time, display data are data for causing the display apparatus 20 to display that there is no stock, and an arrival schedule (e.g., an arrival schedule date). Note that, the display data may be data indicating that the display apparatus 20 is caused not to perform display.

Further, when stock information indicates that the stock quantity is 0, and does not include an arrival schedule for a next time or indicates that there is no arrival schedule, display data are data for causing the display apparatus 20 to display that there is no stock, or data indicating that the display apparatus 20 is caused not to perform display.

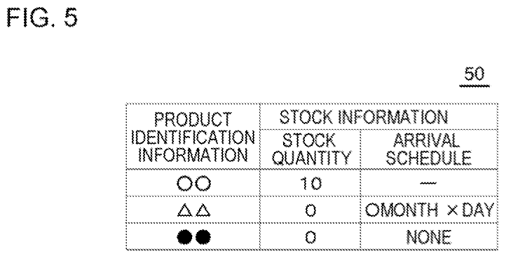

FIG. 5 is a diagram illustrating one example of information stored in the stock management apparatus 50 illustrated in FIG. 1. The stock management apparatus 50 stores stock information of a product associated with product identification information, for each piece of the product identification information. As described above, stock information includes the stock quantity of the product, and also includes information indicating an arrival schedule for a next time, when the stock quantity is 0.

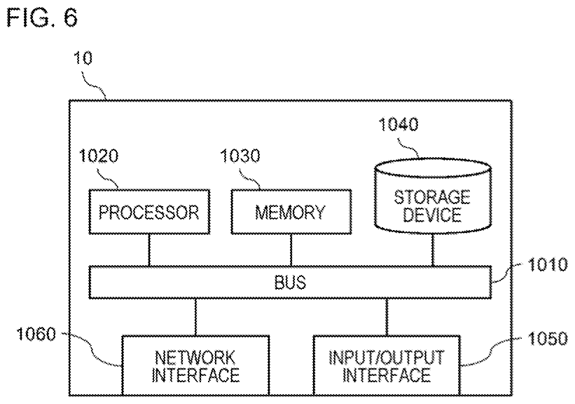

FIG. 6 is a diagram illustrating a hardware configuration example of the display control apparatus 10. The display control apparatus 10 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage to be achieved by a random access memory (RAM) or the like.

The storage device 1040 is an auxiliary storage to be achieved by a hard disk drive (HDD), a solid state drive (SSD), a memory card, a read only memory (ROM), or the like. The storage device 1040 stores a program module achieving each function (e.g., the stock information acquisition unit 110, the apparatus information acquisition unit 120, the display control unit 130, and an apparatus information management unit 160 to be described later) of the display control apparatus 10. The processor 1020 achieves each function associated with the program module by reading each program module in the memory 1030 and executing each program module. Further, the storage device 1040 also functions as the apparatus information storage unit 140 and the display information storage unit 150.

The input/output interface 1050 is an interface for connecting the display control apparatus 10 and various pieces of input/output equipment with each other. For example, the display control apparatus 10 communicates with the stock management apparatus 50 via the input/output interface 1050.

The network interface 1060 is an interface for connecting the display control apparatus 10 to a network. The network is, for example, a local area network (LAN) or a wide area network (WAN). A method of connecting the network interface 1060 to the network may be wireless connection, or may be wired connection. The display control apparatus 10 communicates with the display apparatus 20 via the network interface 1060. Further, the display control apparatus 10 may communicate with the stock management apparatus 50 via the network interface 1060.

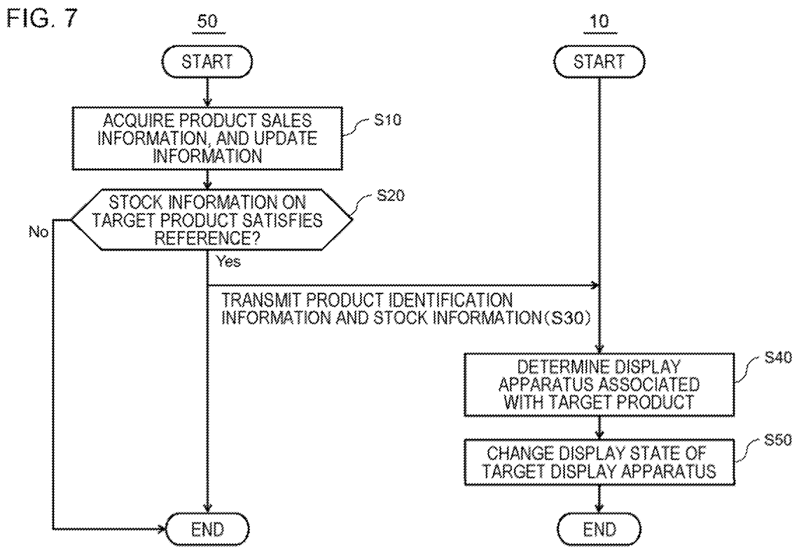

FIG. 7 is a diagram illustrating one example of a flowchart illustrating processing to be performed by the display control apparatus 10 illustrated in FIG. 2. In the example illustrated in FIG. 7, the display control apparatus 10 operates together with the stock management apparatus 50. Further, the stock management apparatus 50 stores in advance a reference number illustrated in FIG. 4. For example, in a case where a reference number is different for each product, the stock management apparatus 50 stores the reference number for each piece of product identification information.

When a customer purchases a product in a store, the product checkout apparatus 40 transmits, to the stock management apparatus 50, product identification information and a purchase quantity of the product. Then, the stock management apparatus 50 reduces the stock quantity associated with the product identification information received from the product checkout apparatus 40 by the received purchase quantity (step S10). Then, the stock management apparatus 50 determines whether the stock quantity after updating is equal to or less than a reference value (step S20). In a case where the stock quantity is equal to or less than the reference value, the stock management apparatus 50 transmits, to the display control apparatus 10, the product identification information and the stock information of the product (step S30). Herein, the stock information to be transmitted includes the stock quantity.

The stock information acquisition unit 110 of the display control apparatus 10 acquires the product identification information and the stock information transmitted from the stock management apparatus 50. Subsequently, the apparatus information acquisition unit 120 reads, from the apparatus information storage unit 140, display apparatus identification information associated with the product identification information acquired by the stock information acquisition unit 110 (step S40). Then, the display control unit 130 changes a display pattern of the display apparatus 20 associated with the display apparatus identification information read in step S40, by using the stock information acquired by the stock information acquisition unit 110 (step S50). Specifically, the display control unit 130 reads information associated with the stock information from the display information storage unit 150, and changes the display pattern of the display apparatus 20 according to the information (step S50).

In this way, according to the present example embodiment, the display control apparatus 10 changes a display pattern of a display apparatus by using information related to stock of a product. Therefore, the display control apparatus 10 can provide a salesperson or an employee in a store of information related to a product associated with a display apparatus 20 via the display apparatus 20.

### Modification Example

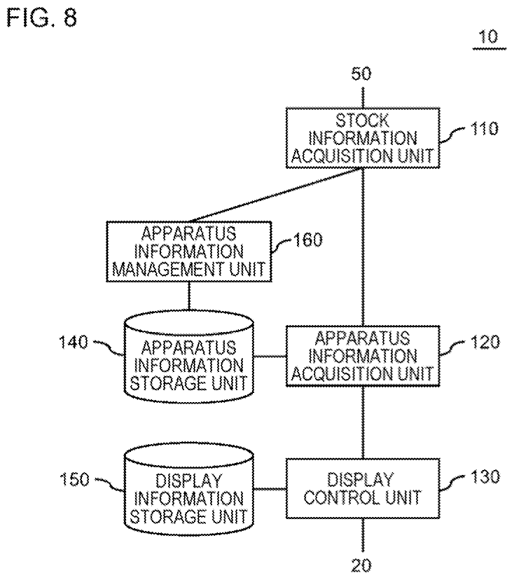

FIG. 8 is a diagram illustrating one example of a functional configuration of a display control apparatus 10 according to a modification example. The display control apparatus 10 according to the present modification example has a configuration similar to that of the display control apparatus 10 according to the example embodiment except that the display control apparatus includes the apparatus information management unit 160.

The apparatus information management unit 160 updates an apparatus information storage unit 140, in a case where a stock quantity is 0 in stock information acquired from a stock management apparatus 50, and the stock information does not include an arrival schedule for a next time or includes information indicating that next-time arrival is not expected. Specifically, the apparatus information management unit 160 erases or disables, in an apparatus information storage unit 140, a correspondence between display apparatus identification information associated with the stock information, and product identification information. This processing is performed, for example, after step S50 in FIG. 7.

In a case where there is a product in which next-time arrival is not expected, it is necessary to use a display apparatus 20 used for the product, for another product. In this case, it is necessary to erase or disable, in the apparatus information storage unit 140, a correspondence between display apparatus identification information of the display apparatus 20, and product identification information. According to the present modification example, the apparatus information management unit 160 performs processing related to the erasing or the disabling. Therefore, load on a salesperson is reduced.

As described above, while the example embodiment according to the present invention has been described with reference to the drawings, these are an example of the present invention, and various configurations other than the above can also be adopted.

Further, in a plurality of flowcharts used in the above description, a plurality of steps (pieces of processing) are described in order, but an order of execution of steps to be performed in each example embodiment is not limited to the order of description. In each example embodiment, the order of illustrated steps can be changed within a range that does not adversely affect a content. Further, the above-described example embodiments can be combined, as far as contents do not conflict with each other.

A part or all of the above-described example embodiment may also be described as the following supplementary notes, but is not limited to the following.

1. A display control apparatus including:

a stock information acquisition unit that acquires product identification information and stock information, the stock information being information related to stock of a product associated with the product identification information in a facility;

an apparatus information acquisition unit that acquires, from an apparatus information storage unit that stores display apparatus identification information for identifying a display apparatus provided on a product shelf within the facility and product identification information associated with the display apparatus in association with each other, the display apparatus identification information associated with the product identification information acquired by the stock information acquisition unit; and

a display control unit that sets the display apparatus associated with the display apparatus identification information acquired by the apparatus information acquisition unit to a display state associated with the stock information acquired by the stock information acquisition unit.

2. The display control apparatus according to supplementary note 1, in which

the stock information indicates that a stock quantity is equal to or less than a reference value.

3. The display control apparatus according to supplementary note 2, in which

the reference value is 0, and

the display control unit causes the display apparatus not to perform display, or causes the display apparatus to display that there is no stock.

4. The display control apparatus according to supplementary note 2, in which

the reference value is 0, and,

in a case where an arrival schedule for a next time is included in the stock information, the display control unit causes the display apparatus to display a timing indicated by the arrival schedule information.

5. The display control apparatus according to supplementary note 2, in which

the reference value is 0,

the display control apparatus further including

an apparatus information management unit that erases or disables a correspondence between the display apparatus identification information associated with the stock information, and the product identification information in the apparatus information storage unit, in a case where an arrival schedule for a next time is not included in the stock information, or in a case where information indicating that next-time arrival is not expected is included in the stock information.

6. The display control apparatus according to supplementary note 2, in which

the stock information includes a stock quantity, and

the display control unit causes the display apparatus to display the stock quantity.

7. A display control method including,

by a computer:

stock information acquisition processing of acquiring product identification information and stock information, the stock information being information related to stock of a product associated with the product identification information in a facility;

apparatus information acquisition processing of acquiring, from an apparatus information storage unit that stores display apparatus identification information for identifying a display apparatus provided on a product shelf within the facility and product identification information associated with the display apparatus in association with each other, the display apparatus identification information associated with the product identification information acquired in the stock information acquisition processing; and

display control processing of setting the display apparatus associated with the acquired display apparatus identification information to a display state associated with the acquired stock information.

8. The display control method according to supplementary note 7, in which

the stock information indicates that a stock quantity is equal to or less than a reference value.

9. The display control method according to supplementary note 8, in which

the reference value is 0, and

by the computer,

in the display control processing, the display apparatus is caused not to perform display, or is caused to display that there is no stock.

10. The display control method according to supplementary note 8, in which

the reference value is 0, and

by the computer, in the display control processing, in a case where an arrival schedule for a next time is included in the stock information, the display apparatus is caused to display a timing indicated by the arrival schedule information.

11. The display control method according to supplementary note 8, in which

the reference value is 0,

the display control method further including, by the computer,

apparatus information management processing of erasing or disabling a correspondence between the display apparatus identification information associated with the stock information, and the product identification information in the apparatus information storage unit, in a case where an arrival schedule for a next time is not included in the stock information, or in a case where information indicating that next-time arrival is not expected is included in the stock information.

12. The display control method according to supplementary note 8, in which

the stock information includes a stock quantity, and

by the computer, in the display control processing, the display apparatus is caused to display the stock quantity.

13. A program causing a computer to include:

a stock information acquisition function of acquiring product identification information and stock information, the stock information being information related to stock of a product associated with the product identification information in a facility;

an apparatus information acquisition function of acquiring, from an apparatus information storage unit that stores display apparatus identification information for identifying a display apparatus provided on a product shelf within the facility and product identification information associated with the display apparatus in association with each other, the display apparatus identification information associated with the product identification information acquired by the stock information acquisition function; and

a display control function of setting the display apparatus associated with the acquired display apparatus identification information to a display state associated with the acquired stock information.

14. The program according to supplementary note 13, in which

the stock information indicates that a stock quantity is equal to or less than a reference value.

15. The program according to supplementary note 14, in which

the reference value is 0, and

the display control function causes the display apparatus not to perform display, or causes the display apparatus to display that there is no stock.

16. The program according to supplementary note 14, in which

the reference value is 0, and,

in a case where an arrival schedule for a next time is included in the stock information, the display control function causes the display apparatus to display a timing indicated by the arrival schedule information.

17. The program according to supplementary note 14, in which

the reference value is 0,

the program further causing the computer to include

an apparatus information management function of erasing or disabling a correspondence between the display apparatus identification information associated with the stock information, and the product identification information in the apparatus information storage unit, in a case where an arrival schedule for a next time is not included in the stock information, or in a case where information indicating that next-time arrival is not expected is included in the stock information.

18. The program according to supplementary note 14, in which

the stock information includes a stock quantity, and

the display control function causes the display apparatus to display the stock quantity.

### REFERENCE SIGNS LIST

10 Display control apparatus
20 Display apparatus
30 Product shelf
40 Product checkout apparatus
50 Stock management apparatus
110 Stock information acquisition unit
120 Apparatus information acquisition unit
130 Display control unit
140 Apparatus information storage unit
150 Display information storage unit
160 Apparatus information control unit

What is claimed is:

1. A display control apparatus comprising:
at least one memory configured to store instructions; and
at least one processor configured to execute the instructions to perform operations, the operations comprising:
acquiring product identification information and stock information, the stock information being information related to stock of a product associated with the product identification information in a facility;
acquiring, from a storage that stores display apparatus identification information for identifying a display apparatus provided on a product shelf within the facility and product identification information associated with the display apparatus in association with each other, the display apparatus identification information associated with the acquired product identification information; and
setting the display apparatus associated with the acquired display apparatus identification information to a display state associated with the acquired stock information.

2. The display control apparatus according to claim 1, wherein
the stock information indicates that a stock quantity is equal to or less than a reference value.

3. The display control apparatus according to claim 2, wherein
the reference value is 0, and
the operations comprise causing the display apparatus not to perform display, or causing the display apparatus to display that there is no stock.

4. The display control apparatus according to claim 2, wherein
the reference value is 0, and,
the operations comprise causing, in a case where an arrival schedule for a next time is included in the stock information, the display apparatus to display a timing indicated by the arrival schedule.

5. The display control apparatus according to claim 2, wherein
the reference value is 0,
the operations further comprise
erasing or disabling a correspondence between the display apparatus identification information associated with the stock information, and the product identification information in the storage, in a case where an arrival schedule for a next time is not included in the stock information, or in a case where information indicating that next-time arrival is not expected is included in the stock information.

6. The display control apparatus according to claim 2, wherein
the stock information includes a stock quantity, and
the operations comprise causing the display apparatus to display the stock quantity.

7. A display control method comprising,
by a computer:
stock information acquisition processing of acquiring product identification information and stock information, the stock information being information related to stock of a product associated with the product identification information in a facility;
apparatus information acquisition processing of acquiring, from a storage that stores display apparatus identification information for identifying a display apparatus provided on a product shelf within the facility and product identification information associated with the display apparatus in association with each other, the display apparatus identification information associated with the product identification information acquired in the stock information acquisition processing; and
display control processing of setting the display apparatus associated with the acquired display apparatus identification information to a display state associated with the acquired stock information.

8. The display control method according to claim 7, wherein
the stock information indicates that a stock quantity is equal to or less than a reference value.

9. The display control method according to claim 8, wherein
the reference value is 0, and
by the computer,
in the display control processing, the display apparatus is caused not to perform display, or is caused to display that there is no stock.

10. The display control method according to claim 8, wherein
the reference value is 0, and
by the computer, in the display control processing, in a case where an arrival schedule for a next time is included in the stock information, the display apparatus is caused to display a timing indicated by the arrival schedule.

11. The display control method according to claim 8, wherein
the reference value is 0,
the display control method further comprising, by the computer,
apparatus information management processing of erasing or disabling a correspondence between the display apparatus identification information associated with the stock information, and the product identification information in the storage, in a case where an arrival schedule for a next time is not included in the stock information, or in a case where information indicating that next-time arrival is not expected is included in the stock information.

12. The display control method according to claim 8, wherein
the stock information includes a stock quantity, and
by the computer, in the display control processing, the display apparatus is caused to display the stock quantity.

13. A non-transitory computer-readable medium storing a program for causing a computer to perform operations, the operations comprising:
acquiring product identification information and stock information, the stock information being information related to stock of a product associated with the product identification information in a facility;
acquiring, from a storage that stores display apparatus identification information for identifying a display apparatus provided on a product shelf within the facility and product identification information associated with the display apparatus in association with each other, the display apparatus identification information associated with the acquired product identification information; and
setting the display apparatus associated with the acquired display apparatus identification information to a display state associated with the acquired stock information.

14. The non-transitory computer-readable medium according to claim 13, wherein
the stock information indicates that a stock quantity is equal to or less than a reference value.

15. The non-transitory computer-readable medium according to claim 14, wherein
the reference value is 0, and
the operations comprise causing the display apparatus not to perform display, or causing the display apparatus to display that there is no stock.

16. The non-transitory computer-readable medium according to claim 14, wherein
the reference value is 0, and,
the operations comprise causing, in a case where an arrival schedule for a next time is included in the stock information, the display apparatus to display a timing indicated by the arrival schedule.

17. The non-transitory computer-readable medium according to claim 14, wherein
the reference value is 0,
the operations further comprise
erasing or disabling a correspondence between the display apparatus identification information associated with the stock information, and the product identification information in the storage, in a case where an arrival schedule for a next time is not included in the stock information, or in a case where information indicating that next-time arrival is not expected is included in the stock information.

18. The non-transitory computer-readable medium according to claim 14, wherein
the stock information includes a stock quantity, and
the operations comprise causing the display apparatus to display the stock quantity.
